(19) United States
(12) Patent Application Publication
(10) Pub. No.: US 2009/0036209 A1
(43) Pub. Date: Feb. 5, 2009

(54) PLAYER CONTROLS FOR USE WITH GAME MACHINES

(75) Inventor: James Cove, Worcestershire (GB)

Correspondence Address: GREENBLUM & BERNSTEIN, P.L.C., 1950 ROLAND CLARKE PLACE, RESTON, VA, 20191, US

(73) Assignee: GAMESMAN LIMITED, Crawley (GB)

(21) Appl. No.: 11/993,746

(22) PCT Filed: Jun. 30, 2006
(86) PCT No.: PCT/GB06/02456

§ 371 Date: May 5, 2008

(30) Foreign Application Priority Data
Jul. 1, 2005 (GB) 0513362.4

(51) Int. Cl. G06F 17/00

(52) U.S. Cl. 463/34

(57) ABSTRACT

A player control assembly (1) can be used with a game machine (7) and comprises a control panel (11) of said machine which has player-operable switches and function indicators for said switches. The assembly (1) further comprises a projector (4) which is arranged to project the function indicators onto the control panel (11) and therefore onto the switches. The switches may be virtual (12-15) or mechanical or both types may be provided. Where mechanical switches are provided the function indicators, which may comprise text/graphics/animations, may be projected relative to these switches. Where virtual switches (12-15) are projected onto said control panel (11) with said function indicators, as part of an image, the assembly (1) may comprise a sensor (5) to identify player interaction with the projected switches (12-15).

The invention relates to a player control assembly for use with a game machine particularly for a credit-operated, game machine.

Credit-operated game machines commonly have a control panel with push buttons for operation by a player during a game. The buttons are associated with electrical switches which control machine functions. The buttons can be used to control different machine functions, at different stages of a game.

The buttons usually have multiple functions dependent on the stage of a game.

Lighting arrangements can be used as function indicators of push buttons during a game. Typically the buttons have internal lamps which can be turned on or off, or flashed, to indicate different functions. It is also known to provide discrete LEDs around a push button which can be selectively operated to indicate different functions and to provide entertaining light displays.

An object of the present invention is to provide a player-control assembly for use with a credit-operated game machine which is more flexible with respect to providing function indicators, in addition to providing additional entertainment possibilities for a player.

According to the invention therefore there is provided a player control assembly for use with a credit-operated game machine comprising a control panel of the machine, having player-operable switches and function indicators for the switches, characterised by the provision of a projector external to the control panel, arranged for projecting said function indicators onto said control panel.

With this arrangement, since the function indicators are projected onto the control panel an enhanced range of function indications is possible.

In addition, there is also the possibility of providing an enhanced range of visual effects and displays for player entertainment purposes.

The function indicators preferably provide indications which comprise text, graphics and/or animations which are provided by the projection of an image onto the control panel, by the projector.

The indications may comprise pictures and/or the animations may comprise rotating/flashing/static/white/multi-coloured animations of lighting arrangements and/or animated sketches, e.g. of cartoon characters etc.

The control panel may comprise one or more switches in the form of mechanical push buttons with mechanical actuating means. Alternatively or additionally, as discussed hereinafter, ‘virtual’ switches which respond to proximity or presence of a player's finger or other object, rather than involving mechanical movement of a part or parts, may be used.

The function indicators may provide indications for each of the switches, which are appropriate to the function of the appropriate switch, e.g. a starting arrangement of switches may include “start”, “nudge”/“hold”, “continue” and “collect” function indicators where the switches relate to a fruit-type game machine.

The image may comprise an alternative arrangement of function indicators for the switches during a different stage of a game, e.g. “bonus”, “continue”, “collect”.

The player control assembly preferably comprises the projector connected to a control unit.

The projector may be provided by any appropriate projection technology which uses a Digital Micro Mirror Display (DMD) chip having a plurality of microscopic mirrors.

With a projector of this kind, when a DMD chip is connected with a digital video or graphic signal, a light source, and a projection lens, the mirrors in the apparatus can reflect an all-digital image onto a screen or other surface using Digital Light Processing™ technology (DLP).

The image may be subject to “keystone correction”, to alter the appearance and perspective of the image to a player.

Therefore, the control unit most preferably comprises software for interaction with the projector.

The control unit preferably has a connection means for connection to a processing unit of an entertainment machine.

The connection means is most preferably provided by a series of electrical pins associated with a printed circuit board, for interconnection with a series of electrical receivers on the processing unit.

Most preferably still, the control unit comprises software for providing an interface between the processing unit and the player control assembly.

The player control assembly may be provided within the housing of the machine and is most preferably mounted behind an aperture provided in the housing of the machine for projection therefrom.

Most preferably however, in addition to the function indicators, the image comprises one or more virtual switches and a sensing means is provided as part of the player control assembly, for determining the actuation of each said switch.

A virtual switch may be actuated by contact with the relevant part of said image with an actuating member, for example, by a player's finger or other instrument such as a wand.

The sensing means most preferably comprises a laser sensor.

The laser sensor may be an Area Detection, Definite-reflective laser sensor, which enables a laser to be emitted over a wide area and detects objects in the path of the laser by detecting reflected laser beams.

The laser sensor may direct laser beams parallel to, and just above the projected image.

Actuation of a virtual switch is identified by interruption of one or more of the beams, causing a reflection of the beams back to the sensor. The sensor is therefore capable of identifying a location of interruption of the beams and producing associated data.

The sensor may send the data to the control unit for assessment and identification of the actuated virtual switch.

Therefore the control unit preferably comprises further software for assessing and processing data from the sensor.

Having assessed and processed the location, the control unit may instruct the processing unit to perform the function corresponding to the virtual switch.

The player control assembly is most preferably an integrated unit comprising the control unit, projector and sensor, for connection to the processing unit via the control unit.

In an alternative embodiment of the invention, the sensing means may comprise a touch screen or pad sensor.

The touch screen or pad sensor may sit over the control panel. In this case, actuation of a virtual switch is identified by the touch screen or pad sensor.

The touch screen or pad sensor may be connected to and provide data to the processing unit of the machine. However, preferably, the touch screen or pad sensor is connected to the control unit, and is part of the player control assembly.

The player control assembly of the invention may be used with a credit-operated player-operable game machine of the kind having a cabinet with a front panel with a game display and a strip-shaped area beneath the panel which area provides the push-button control panel of the assembly of the present invention. The machine may be of the fruit machine kind having a main display comprising actual or simulated rotatable reels. However, the invention can also be used with other kinds of game machines.

The invention will now be described further by way of example only and with reference to the accompanying drawing in which:—

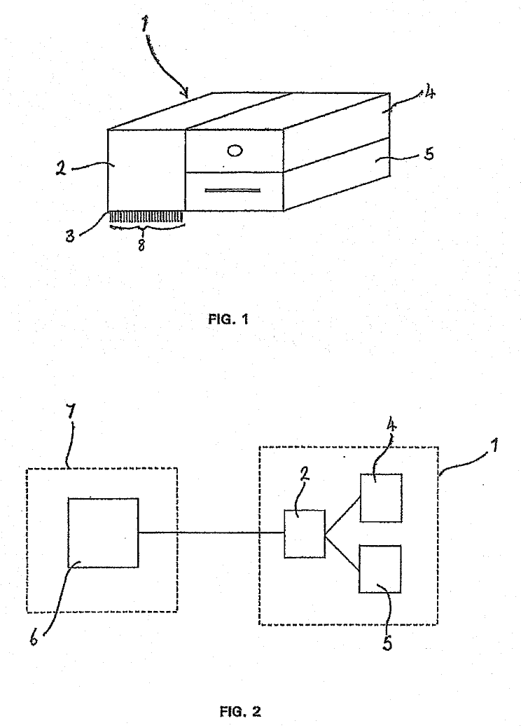

FIG. 1 is a diagrammatic perspective view of a player control assembly according to the invention;

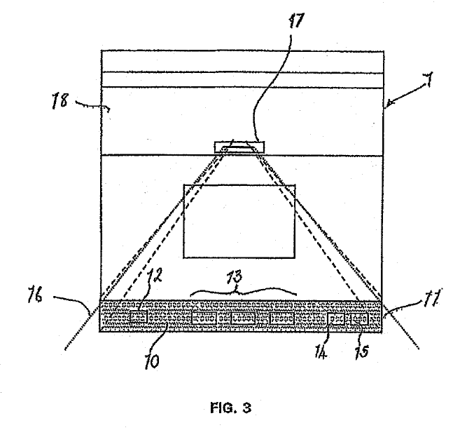

FIG. 2 is a diagrammatic block circuit diagram according to FIG. 1; and

FIG. 3 is a plan view of the invention according to FIG. 1 in use with a player-operable game machine.

As shown in the drawings, a player control assembly 1 for connection to a game machine 7, is an integrated unit comprising a micro-processor based control unit 2 having a printed circuit board 3, a projector 4 and a sensor 5.

The player control assembly connects to a microprocessor-based processing unit 6 of the machine 7 by connection means in the form of electrical pins 8 on printed circuit board 3, which interconnect with electrical receivers (not shown) on the processing unit 6. The connection means allows a player control assembly to be conveniently attached and integrated into a machine.

The printed circuit board 3 of the control unit 2 comprises software for interfacing with the projector 4 and processing unit 6. The control unit is additionally provided with a power supply, which may be an internal power supply, i.e. a battery, or a connection to an external power supply.

The control unit 2 is therefore capable of receiving information from the processing unit 6, processing the information and communicating with the projector 4, providing a projected image 10 onto a control panel 11 of a housing 12 of the machine 7.

The projector 4 is therefore calibrated by the control unit 2, to project the image 10 onto the control panel 11. This may require a “keystone correction” as necessary to ensure that the correct perspective is presented to a player on the control panel 11.

The projector 4 may be a Digital Micro Mirror Display (DMD) using Digital Light Processing (DLP) line, which forms images using microscopic mirrors. In this case, the projector 4 comprises a high-power lamp, a prism and a semiconductor chip. The semiconductor chip is covered in more than a million mirrors, each with a hinge forming an array of microscopic mirrors (Digital Micromirror Device (DMD)). The lamp shines light through the prism, which then splits the light into component colours red, green and blue. Each colour beam then hits a different mirror on the semiconductor chip.

Depending on the information from the control unit 2, the semiconductor turns the mirrors on their hinges to reflect the coloured beams to create a monochromatic image, which is then reflected back to the prism. The prism recombines the colours to form the full colour image 10, which is projected on to the control panel 11.

Alternatively, the projector 4 may be an LCD projector. In this case, the projector 4 comprises a mirror covered with an LCD (liquid crystal display) and a lamp. The liquid crystals in the display are affected by electric current which can be used to twist the liquid crystals in the display, which twist predictably in response to the application of a particular voltage. The lamp shines high-intensity light onto the mirror with the LCD.

Dependent on the information received from the control unit 2, the crystals may twist, some of the liquid crystals letting reflected light through, and others blocking light, to create the image 10 on the control panel 11.

As shown in FIG. 3, the image 10 comprises virtual switches, e.g. 11, 12, 13, 14, 15 (i.e. “start”, “nudge”/“hold”, “collect”, “continue”) and additional features including graphics, animations and text providing function indicators, e.g. lighting arrangements upon and surrounding the virtual switches. The lighting arrangements may include rotating/flashing/static/white/multi-coloured dots and shapes to indicate particular functions of the virtual switches.

The image 10 is changeable according to the stage of a game, including the arrangement, position and number of virtual switches projected as part of the image 10. Accordingly, appropriate function indicators are also projected as part of the image 10.

A player actuates a virtual switch by contact with the relevant part of the image 10, relating to the virtual switch. The contact is made by an actuating member, e.g. a player's finger or a wand or other instrument provided with the assembly.

The actuation is detected by the sensor 5.

The sensor 5 may be a laser sensor, provided as part of the integrated player control assembly, e.g. an Area Detection, Definite-reflective Laser Sensor. The laser sensor 5 projects laser beams 16 parallel with, and at a distance just above the image 10.

The actuation of a virtual switch by an actuating member causes interruption of some of the laser beams 16, at which point the beams are reflected off of the actuating member and back to the sensor 5. The sensor 5 collects the reflected beams and produces data for communication to the control unit 2.

The control unit 2 comprises further software for interfacing, assessing and processing the data received from the sensor 5, which is then used to instruct the processing unit 6 to perform a particular function associated with the actuation of a virtual switch.

In an alternative embodiment of the invention, a touch screen or sensor pad connected to the control unit 2 of the projection apparatus 1, may be provided as part of the control panel 11. In this case, the interaction of the player with the image 10, i.e. by a finger or other instrument, causes a signal to be sent to the control unit 2.

The projection apparatus 1 is mounted behind an aperture 17 in an upper panel 18 of a housing of the machine 7, such that the projector 4 and the sensor 5 are able to project the image 10 and laser beams 16 respectively, through said aperture 17.

In use, a player actuates a machine 7 for play of a game by inserting sufficient credit. In response to this, the processing unit 6 of the machine 7 communicates with the control unit 2, which interprets the information for projection of the image 10 and laser beams 16 onto control panel 11.

The image 10 may present a starting arrangement of virtual switches, e.g. 11, 12, 13, 14, in addition to function indicators. A player can then, for example, initiate play of the game, by actuating a “start” switch 11. Further play may include the use of virtual switches, which are appropriate to the stage of the game, the switches being updated for every stage of the game by the interfacing between the processing unit 6 and the control unit 2.

For example, during play of a game, the image 10 may change the number, function and layout of the virtual switches available dependent on the requirements of the stage of the game, including the function indicators.

At the end of a game, or end of a series of games, when there is no longer any credit in the machine, the player control assembly 1 is de-activated, i.e. the processing unit 6 no longer interfaces with the control unit 2, and the projection of the image 10 and laser beams 16 cease. The game can no longer be played.

It is of course to be understood that the invention is not intended to be restricted to the details of the above embodiment, which are described by way of example only.

Thus for example, the machine may be any game machine which requires a player-operable control panel and the image may present any combination of text, graphics and animations at any stage of a game as function indicators.

The player control assembly may not be an integrated unit, but may comprise separate components, which may be mounted within a game machine.

The image may only provide function indicators onto a control panel, which may comprise mechanical switches for actuation.

1-26. (canceled)

27. A player control assembly for use with a credit-operated game machine comprising a control panel of the machine having player-operable switches and function indicators for the switches, and a projector external to the control panel arranged for projecting said function indicators onto said control panel.

28. The player control assembly according to claim 27, wherein the function indicators provide indications which comprise text, graphics and/or animations which are provided by the projection of an image onto the control panel by the projector.

29. The player control assembly according to claim 28, wherein the indications comprise pictures and/or the animations comprise rotating/flashing/static/white/multi-colored animations of lighting arrangements and/or animated sketches.

30. The player control assembly according to claim 27, wherein the control panel comprises one or more switches in the form of mechanical push buttons with mechanical actuating means.

31. The player control assembly according to claim 27, wherein the control panel comprises one or more virtual switches which respond to proximity or presence of a player's finger or other object.

32. The player control assembly according to claim 30, wherein the function indicators provide indications for each of the switches which are appropriate to the function of each respective switch.

33. The player control assembly according to claim 28, wherein the image comprises alternative arrangements of function indicators for the switches (12-15) during different stages of a game.

34. The player control assembly according to claim 27, wherein the projector is connected to a control unit.

35. The player control assembly according to claim 28, wherein the image is subject to keystone correction, to alter the appearance and perspective of the image to a player.

36. The player control assembly according to claim 34, wherein the control unit comprises software for interaction with the projector.

37. The player control assembly according to claim 34, wherein the control unit has a connection means for connection to a processing unit of the credit-operated game machine.

38. The player control assembly according to claim 37, wherein the connection means is provided by a series of electrical pins associated with a printed circuit board for interconnection with a series of electrical receivers on the processing unit.

39. The player control assembly according to claim 37, wherein the control unit comprises software for providing an interface between the processing unit and the player control assembly.

40. The player control assembly according to claim 27, wherein the player control assembly is provided within a housing of the machine and is mounted behind an aperture provided in the housing of the machine for projection therefrom.

41. The player control assembly according to claim 31, wherein the function indicators provide indications which comprise text, graphics and/or animations which are provided by the projection of an image onto the control panel by the projector, and the image comprises one or more virtual switches, and a sensing means is provided as part of the player control assembly for determining the actuation of each said switch.

42. The player control assembly according to claim 41, wherein each virtual switch is actuated by contact with the relevant part of said image using an actuating member.

43. The player control assembly according to claim 41, wherein the sensing means comprises a laser sensor.

44. The player control assembly according to claim 43, wherein the laser sensor directs laser beams parallel to, and just above the projected image.

45. The player control assembly according to claim 44, wherein actuation of each virtual switch is identified by interruption of one or more of the beams.

46. The player control assembly according to claim 45, wherein interruption of one or more of the beams causes a reflection of the beams back to the sensor to identify the location of interruption and produce associated data.

47. The player control assembly according to claim 46, wherein the sensor sends the data to the control unit for assessment and identification of the actuated virtual switch.

48. The player control assembly according to claim 47, wherein the control unit comprises further software for assessing and processing data from the sensor.

49. The player control assembly according to claim 48, wherein the control unit instructs the processing unit to perform the function corresponding to the respective actuated virtual switch.

50. The player control assembly according to claim 41, wherein the sensing means comprises a touch screen or pad sensor, where actuation of a virtual switch is identified by the touch screen or pad sensor, which is connected to and provides data to a processing unit of the machine.

51. The player control assembly according to claim 27, wherein the credit-operated player-operable game machine has a cabinet with a front panel with a game display and a strip-shaped area beneath the panel which area provides a push-button control panel of the assembly.
